(19) United States
(12) Patent Application Publication
(10) Pub. No.: US 2012/0124902 A1
(43) Pub. Date: May 24, 2012

(54) METHOD FOR CONTROLLING GREENHOUSE AND SYSTEM FOR THE SAME

(75) Inventors: Ae Kyeung MOON, Daegu (KR); Kyu Hyung KIM, Daegu (KR); Song LI, Gyeonggi-do (KR); Eun Ju LEE, Gyeongbuk (KR)

(73) Assignee: Electronics & Telecommunications Research Institute, Daejeon (KR)

(21) Appl. No.: 13/281,467

(22) Filed: Oct. 26, 2011

(30) Foreign Application Priority Data
Nov. 23, 2010 (KR) 10-2010-0117075

(51) Int. Cl. A01G 9/14

(52) U.S. Cl. 47/17

(57) ABSTRACT

A method for controlling a greenhouse, which can adaptively control a greenhouse depending on the kind of crop growing in greenhouse provided. System for controlling a greenhouse may comprise a greenhouse environment control information distribution device and a greenhouse control device. Greenhouse environment control information distribution device may comprise: information receiving unit for receiving information of a crop growing in a greenhouse, information of sensors mounted in greenhouse, and information of actuators; selection unit for selecting a sensor service and an actuator service, which correspond to received sensor information and actuator information, from a sensor service registry and an actuator service registry, respectively; mapping unit for mapping a sensor for providing selected sensor service to an actuator for providing selected actuator service; and distribution unit for extracting growth environment information from a database based on crop information and mapping information and distributing extracted information to greenhouse control device.

### CROSS-REFERENCE TO RELATED PATENT APPLICATION

This application claims the benefit of Korean Patent Application No. 10-2010-0117075, filed on Nov. 23, 2010, in the Korean Intellectual Property Office, the disclosure of which is incorporated herein in its entirety by reference.

### BACKGROUND OF THE INVENTION

1. Field of the Invention

The present invention relates to a method and system for controlling a greenhouse and, more particularly, to a method for controlling a greenhouse, which can adaptively control a greenhouse depending on the kind of crop growing in the greenhouse, and a system for the same.

2. Description of the Related Art

Typically, most of the crops cultivated in a greenhouse are affected by temperature, humidity, sunshine, water supply, carbon dioxide, etc., by which the growth rate, yield, and quality such as taste of crops are determined. Thus, an apparatus for maintaining the temperature, humidity, sunshine, etc. has been used which, however, should be operated directly by a farmer or farm manager in the greenhouse.

Accordingly, the farmer or farm manager has operated the apparatus for maintaining the temperature, humidity, sunshine, etc. under conditions determined based on his or her expertise. In this case, to increase the yield of crops, the farmer or farm manager should accurately control, monitor and manage the apparatus for maintaining the temperature, humidity, sunshine, etc. at all times, which is very troublesome to the farmer or farm manager.

Conventionally, the greenhouse has been automatically operated to solve this problem. However, there are various types of greenhouses such as glass greenhouse, vinyl greenhouse, solar heated greenhouse, plant factory using artificial light, etc., and thus various sensors for monitoring the conditions of the greenhouse and various actuators corresponding to the various sensors are used.

Despite these various conditions, the growth of crops has been automatically controlled using a single greenhouse system. In this case, the growth of crops is automatically controlled based on predetermined information regardless of the growth conditions of crops in the greenhouse such as information about temperature, humidity, light intensity, etc. for optimizing the growth of crops. As a result, it is difficult to efficiently control the growth environment of crops, which in turn may affect the yield of crops. Moreover, when a pre-built greenhouse control software program is rebuilt according to the growth conditions of crops in a greenhouse, significant costs are incurred.

### SUMMARY OF THE INVENTION

The present invention has been made in an effort to solve the above-described problems associated with prior art, and a first object of the present invention is to provide a system for adaptively controlling a greenhouse depending on the kind of crop growing in the greenhouse.

A second object of the present invention is to provide a method for distributing greenhouse environment control information depending on the kind of crop.

A third object of the present invention is to provide a method for controlling a greenhouse environment greenhouse depending on greenhouse environment control information determined based on the kind of crop growing in the greenhouse.

According to an aspect of the present invention to achieve the first object of the present invention, there is provided a system for controlling a greenhouse, the system comprising a greenhouse environment control information distribution device and a greenhouse control device, wherein the greenhouse environment control information distribution device may comprise: an information receiving unit for receiving information of a crop growing in a greenhouse, information of sensors mounted in the greenhouse, and information of actuators; a selection unit for selecting a sensor service and an actuator service, which correspond to the received sensor information and actuator information, from a sensor service registry and an actuator service registry, respectively; a mapping unit for mapping a sensor for providing the selected sensor service to an actuator for providing the selected actuator service; and a distribution unit for extracting growth environment information from a database based on the crop information and the mapping information and distributing the extracted information to the greenhouse control device.

According to another aspect of the present invention to achieve the second object of the present invention, there is provided a method for distributing greenhouse environment control information, the method comprising: receiving information of a crop growing in a greenhouse, information of sensors mounted in the greenhouse, and information of actuators; selecting a sensor service, which corresponds to the sensor information, from a sensor service registry; selecting an actuator service, which corresponds to the actuator information, from an actuator service registry; mapping a sensor for providing the selected sensor service to an actuator for providing the selected actuator service; and extracting growth environment information from a database based on the crop information and the mapping information and distributing the extracted information.

According to still another aspect of the present invention to achieve the third object of the present invention, there is provided a method for controlling a greenhouse, the method comprising: receiving growth environment information of a crop growing in a greenhouse, which is determined based on the kind of crop growing in the greenhouse and distributed by a greenhouse environment control information distribution device; comparing the received growth environment information with greenhouse environment information, which is measured by sensors for sensing the greenhouse environment information, to determine whether the growth environment information coincides with the greenhouse environment information; if it is determined that the growth environment information does not coincide with the greenhouse environment information, detecting a sensor corresponding to the inconsistent environment information; and actuating an actuator mapped to the detected sensor.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram showing the structure of a greenhouse control system in accordance with an exemplary embodiment of the present invention;

FIG. 2 is a flowchart showing a method for distributing greenhouse environment control information in accordance with another exemplary embodiment of the present invention; and

FIG. 3 is a flowchart showing a method for controlling a greenhouse environment in accordance with still another exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. Like reference numerals in the drawings denote like elements, and thus repeated descriptions will be omitted.

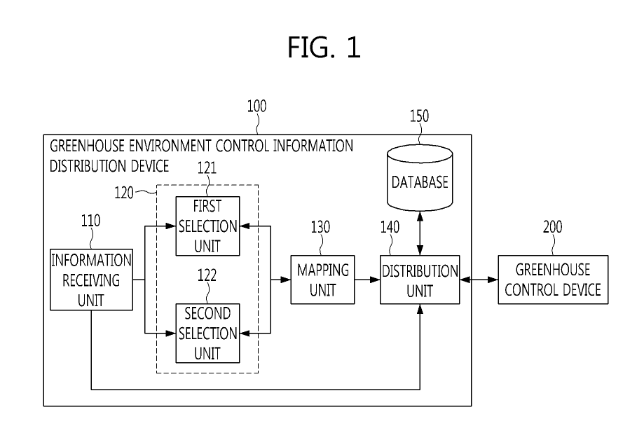

FIG. 1 is a schematic diagram showing the structure of a greenhouse control system in accordance with an exemplary embodiment of the present invention, in which a greenhouse control device 200 receives information from a greenhouse environment control information distribution device 100 via wire. When the information is transmitted wirelessly, the system may have an antenna and the structure of the greenhouse control system may be changed into a structure for receiving wireless data.

Referring to FIG. 1, the greenhouse system may comprise the greenhouse environment control information distribution device 100 and the greenhouse control device 200. The greenhouse environment control information distribution device 100 may comprise an information receiving unit 110, a selection unit 120, a mapping unit 130, a distribution unit 140, and a database 150. The selection unit 120 may comprise a first selection unit 121 and a second selection unit 122.

According to this exemplary embodiment of the present invention, the greenhouse environment control information distribution device 100 and the greenhouse control device 200 may communicate with each other via a communication network for wired or wireless bidirectional communication. Examples of wireless communication may include, but not limited to, Bluetooth, Zigbee, infrared data association (IrDa), and radio frequency identification (RFID).

The information receiving unit 110 receives information of a crop growing in a greenhouse, information of sensors mounted in the greenhouse, and information of actuators corresponding to the sensors mounted in the greenhouse from a user.

TABLE 1

| | | | Heating | | Cooling | | Ventilation | | | Curtain | | | | Watering | |
|---|---|---|---|---|---|---|---|---|---|---|---|---|---|---|---|
| | | | system | | system | | system | | | system | | | | system | |
| Class | Subclass | Details | 1 | 2 | 3 | 4 | 5 | 6 | 7 | 8 | 9 | 10 | 11 | 12 | 13 |
| Outside of | Air temp. | — | ◯ | ◯ | ◯ | ◯ | ◯ | ◯ | ◯ | ◯ | ◯ | ◯ | ◯ | ◯ | ◯ |
| greenhouse | Humidity | Relative humidity | | | | | | | | | | | | | |
| | | Steam saturation | | | | | | | | | | | | | |
| | Light | Light intensity | ◯ | | ◯ | ◯ | ◯ | ◯ | ◯ | ◯ | ◯ | ◯ | ◯ | | |
| | Wind | Anemometer (air flow | | | | | | | | | | | | | |
| | direction & | meter) | | | | | | | | | | | | | |
| | velocity | Anemoscope | | | | | | | | | | | | | |
| | | Aerovane | | | | | | | | | | | | | |
| | Rain | Rain gauge | | | | | | | | | | | | | |
| | | Rain/snow gauge | | | | | | | | | | | | | |
| | | Snow gauge | | | | | | | | | | | | | |
| Inside of | Temperature | Air temperature | ◯ | ◯ | ◯ | ◯ | ◯ | ◯ | ◯ | ◯ | ◯ | ◯ | ◯ | ◯ | ◯ |
| greenhouse | | Plant temperature | ◯ | ◯ | ◯ | ◯ | ◯ | ◯ | ◯ | ◯ | ◯ | ◯ | ◯ | ◯ | ◯ |
| | | Root zone temperature | ◯ | ◯ | ◯ | ◯ | | | | ◯ | ◯ | ◯ | ◯ | ◯ | ◯ |
| | Humidity | Relative humidity | ◯ | | | ◯ | ◯ | ◯ | ◯ | | | | | | ◯ |
| | | Steam saturation | ◯ | | | ◯ | ◯ | ◯ | ◯ | | | | | | ◯ |
| | | Root zone water content | | ◯ | | ◯ | ◯ | ◯ | ◯ | | | | | ◯ | ◯ |
| | Light | Light intensity | ◯ | | ◯ | ◯ | ◯ | ◯ | ◯ | ◯ | ◯ | ◯ | ◯ | | |
| | | Light quality | ◯ | | ◯ | ◯ | ◯ | ◯ | ◯ | ◯ | ◯ | ◯ | ◯ | | |
| | Soil | Root zone pH | | | | | | | | | | | | | |
| | | Root zone EC | | | | | | | | | | | | | |
| | | R. zone inorganics | | | | | | | | | | | | | |
| | Air | CO₂ concentration in air | | | | | ◯ | ◯ | ◯ | | | | | | |
| | composition | R. zone dissolved | | | | | | | | | | | | | |
| | | oxygen | | | | | | | | | | | | | |

In Table 1, 1: air heating; 2: root zone heating; 3: cooler; 4: fan; 5: skylight window; 6: side wall window; 7: fan; 8: inner ceiling; 9: inner side wall; 10: black window; 11: outside of roof; 12: main; and 13: sprinkler.

Referring to table 1, the information receiving unit 110 receives information of sensors mounted in the greenhouse such as a temperature sensor, a light sensor, a humidity sensor, a CO₂ sensor, etc. and information of actuators corresponding to the sensors mounted in the greenhouse such as a temperature control actuator, a light control actuator, a humidity control actuator, a CO₂ control actuator, etc. from a user.

According to this embodiment of the present invention, the sensor information may comprise information of weather-related sensors such as a wind direction sensor, a wind velocity sensor, a snow sensor, a rain sensor, etc., information of soil-related sensors such as an electrical conductivity (EC) sensor, a pH sensor, an inorganic component sensor, etc., and information of ambient air-related sensors such as a temperature sensor, a humidity sensor, a light sensor, a CO₂ sensor, etc.

According to this exemplary embodiment of the present invention, the actuator information may comprise information of weather-related actuators such as a wind direction control actuator, a wind velocity control actuator, a snow control actuator, a rain control actuator, etc., information of ambient air-related actuators such as a temperature control service, a humidity control service, a light control service, a CO₂ control service, etc., and information of soil-related actuators such as an EC control actuator, a pH control actuator, an inorganic component control actuator, etc.

The first selection unit 121 selects a sensor service, which corresponds to the sensor information received from the information receiving unit 110, from a sensor service registry. According to this exemplary embodiment of the present invention, the sensor service registry may comprise a temperature measurement service, a humidity measurement service, a light measurement service, a CO₂ measurement service, a wind direction measurement service, a wind velocity measurement service, an EC measurement service, a pH measurement service, and an inorganic component measurement service. The first selection unit 121 selects a sensor service such as the temperature control service, the humidity control service, and the CO₂ control service, which correspond to the sensor information received from the information receiving unit 110, i.e., the information of the temperature sensor, the humidity sensor, and the CO₂ sensor, from the sensor service registry.

The second selection unit 122 selects an actuator service, which corresponds to the actuator information received from the information receiving unit 110, from an actuator service registry. According to this exemplary embodiment of the present invention, the actuator registry may comprise a temperature control service, a humidity control service, a light control service, a CO₂ control service, an EC control service, a pH control service, and an inorganic component control. The second selection unit 122 selects an actuator service such as the temperature control service, the humidity control service, and the CO₂ control service, which correspond to the actuator information received from the information receiving unit 110, from the actuator service registry.

The mapping unit 130 maps a sensor, which corresponds to the sensor service selected by the first selection unit 121, to an actuator, which provides the actuator service selected by the second selection unit 122. According to this exemplary embodiment of the present invention, the mapping unit 130 compares the sensor service selected by the first selection unit 121 under the control of the greenhouse control device 200, i.e., the concentration of CO₂ in the greenhouse measured by the CO₂ sensor for providing the CO₂ measurement service, with a predetermined concentration of CO₂. If it is determined that the measured concentration of CO₂ in the greenhouse is lower than the predetermined concentration, the mapping unit 130 maps the sensor, which corresponds to the sensor service selected by the first selection unit 121, to the actuator, which provides the actuator service selected by the second selection unit 122, thereby actuating the actuator for providing the CO₂ control service corresponding to the sensor for providing the CO₂ measurement service.

The distribution unit 140 extracts growth environment information from the pre-built database 150 based on the mapping information of the sensor and the actuator received from the information receiving unit 110 and distributes the extracted information to the greenhouse control device 200.

TABLE 2

| Target crop | Class | Subclass | Details | | | |
|---|---|---|---|---|---|---|
| Paprika | Inside of | Temperature | Air temperature | After | Day: 23-26° C. | Daily |
| | greenhouse | | | transplanting | Night: 21-22° C. | average: 21- |
| | | | | After | Day: 22-24° C. | 22° C. |
| | | | | flowering | Night: 18-20° C. | |

| | | |
|---|---|---|
| | Root zone | 21° C. |
| | temp. | |
| Humidity | Relative | 70-80% |
| | humidity | |

| | | |
|---|---|---|
| Steam | 3-7 g/m³ | 17-18° C./55-80% |
| saturation | | 19-20° C./60-80% |
| | | 21-22° C./65-80% |
| | | 23-25° C./70-85% |
| | | 26-28° C./75-85% |
| | | 29-30° C./80-85% |

| | | |
|---|---|---|
| Light | Light intensity | 30,000-40,000 lux |
| | | (Total photosynthesis: Morning 70-80%) |
| | Light quality | Wavelength range nm |
| Soil | Root zone pH | 5.5-6.5 |
| composition | Root zone EC | 2.5-3.5 |
| Air composition | CO₂ conc. in air | 500 ppm (300-1,000 ppm)/800-1,000 ppm |

Referring to table 2, the distribution unit 140 extracts growth environment information of paprika from the pre-built database 150 based on the crop information received from the information receiving unit 110 and the mapping information of the sensor and the actuator received from the information receiving unit 110, i.e., the information of the temperature control actuator corresponding to the temperature sensor, the humidity control actuator corresponding to the humidity sensor, the light control actuator corresponding to the light sensor, and the CO₂ control actuator corresponding to the CO₂ sensor, and distributes the extracted information to the greenhouse control device 200.

The greenhouse control device 200 receives environment control information, which is determined and distributed based on the kind of crop growing in the greenhouse, from the greenhouse environment control information distribution device 100. Moreover, the greenhouse control device 200 controls the greenhouse based on the environment control information received from the greenhouse environment control information distribution device 100. According to this exemplary embodiment of the present invention, the greenhouse control device 200 determines whether the growth environment information, which is distributed and received from the greenhouse environment control information distribution device 100, coincides with greenhouse environment information, which is measured by the sensors mounted in the greenhouse. According to this exemplary embodiment of the present invention, if it is determined that the growth environment information, which is distributed and received from the greenhouse environment control information distribution device 100, does not coincide with the greenhouse environment information, which is measured by the sensors mounted in the greenhouse, the greenhouse control device 200 detects a sensor corresponding to the inconsistent information and actuates an actuator mapped to the detected sensor.

According to this exemplary embodiment of the present invention, when the growth environment information, which is distributed and received from the greenhouse environment control information distribution device 100, does not coincide with the greenhouse environment information, which is measured by the sensors mounted in the greenhouse, if it is determined by the greenhouse control device 200 that the sensor corresponding to the inconsistent environment information is the CO₂ sensor for providing the CO₂ measurement service, and if it is determined from the comparison that the measured concentration of CO₂ in the greenhouse is lower than the predetermined concentration, the greenhouse control device 200 actuates the actuator for providing the CO₂ control service corresponding to the sensor for providing the CO₂ measurement service.

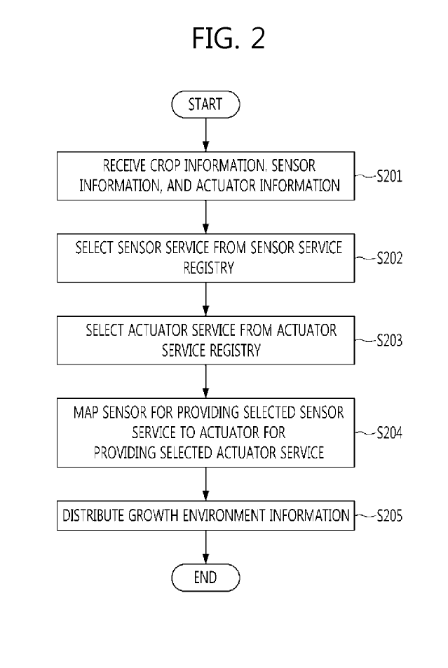

Next, a method for distributing greenhouse environment control information in accordance with another exemplary embodiment of the present invention will be described in more detail with reference to FIG. 2.

FIG. 2 is a flowchart showing a method for distributing greenhouse environment control information in accordance with another exemplary embodiment of the present invention.

Referring to FIG. 2, a greenhouse environment control information distribution device 100 receives information of a crop growing in a greenhouse, information of sensors mounted in the greenhouse, and information of actuators corresponding to the sensors mounted in the greenhouse (S201). According to this exemplary embodiment of the present invention, the sensor information may comprise information of weather-related sensors such as a wind direction sensor, a wind velocity sensor, a snow sensor, a rain sensor, etc., information of soil-related sensors such as an electrical conductivity (EC) sensor, a pH sensor, an inorganic component sensor, etc., and information of ambient air-related sensors such as a temperature sensor, a humidity sensor, a light sensor, a CO₂ sensor, etc.

According to this exemplary embodiment of the present invention, the actuator information may comprise information of weather-related actuators such as a wind direction control actuator, a wind velocity control actuator, a snow control actuator, a rain control actuator, etc., information of ambient air-related actuators such as a temperature control service, a humidity control service, a light control service, a CO₂ control service, etc., and information of soil-related actuators such as an EC control actuator, a pH control actuator, an inorganic component control actuator, etc.

The greenhouse environment control information distribution device 100 selects a sensor service, which corresponds to the sensor information, from a sensor service registry (S202). According to this exemplary embodiment of the present invention, the sensor service registry may comprise a temperature measurement service, a humidity measurement service, a light measurement service, a CO₂ measurement service, a wind direction measurement service, a wind velocity measurement service, an EC measurement service, a pH measurement service, and an inorganic component measurement service. The greenhouse environment control information distribution device 100 selects a sensor service such as the temperature control service, the humidity control service, and the CO₂ control service, which correspond to the sensor information, i.e., the information of the temperature sensor, the humidity sensor, and the CO₂ sensor, from the sensor service registry.

The greenhouse environment control information distribution device 100 selects an actuator service, which corresponds to the actuator information, from an actuator service registry (S203). According to this exemplary embodiment of the present invention, the actuator registry may comprise a temperature control service, a humidity control service, a light control service, a CO₂ control service, an EC control service, a pH control service, and an inorganic component control. The greenhouse environment control information distribution device 100 selects an actuator service such as the temperature control service, the humidity control service, and the CO₂ control service, which correspond to the actuator information received, from the actuator service registry.

The greenhouse environment control information distribution device 100 maps a sensor for providing the selected sensor service to an actuator for providing the selected actuator service (S204). According to this exemplary embodiment of the present invention, the greenhouse environment control information distribution device 100 compares the sensor service selected under the control of a greenhouse control device 200, i.e., the concentration of CO2 in the greenhouse measured by the CO2 sensor for providing the CO2 measurement service, with a predetermined concentration of CO2. If it is determined that the measured concentration of CO2 in the greenhouse is lower than the predetermined concentration, the greenhouse environment control information distribution device 100 maps the sensor corresponding to the sensor service selected to the actuator for providing the actuator service selected, thereby actuating the actuator for providing the CO₂ control service corresponding to the sensor for providing the CO₂ measurement service. The greenhouse environment control information distribution device 100 extracts growth environment information from a database based on the crop information and the mapping information and distributes the extracted information to the greenhouse control device 200 (S205).

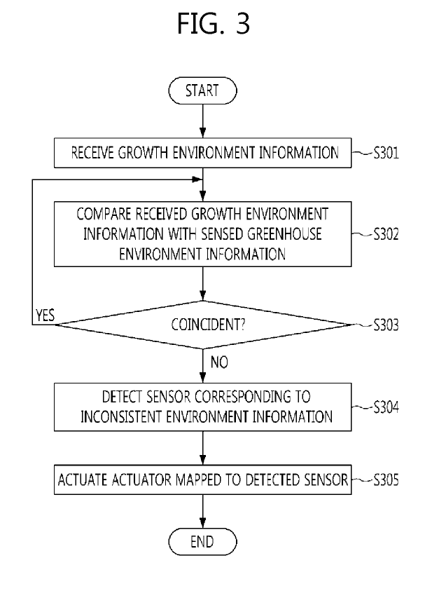

Next, a method for controlling a greenhouse environment in accordance with still another exemplary embodiment of the present invention will be described in more detail with reference to FIG. 3.

FIG. 3 is a flowchart showing a method for controlling a greenhouse environment in accordance with still another exemplary embodiment of the present invention.

Referring to FIG. 3, a greenhouse control device 200 receives growth environment information of a crop growing in a greenhouse, which is determined and distributed based on the kind of crop growing in the greenhouse, from a greenhouse environment control information distribution device 100 (S301).

The greenhouse control device 200 compares the received growth environment information with greenhouse environment information measured by sensors mounted in the greenhouse (S302). According to this exemplary embodiment of the present invention, the greenhouse control device 200 determines whether the growth environment information, which is distributed and received from the greenhouse environment control information distribution device 100, coincides with the greenhouse environment information, which is measured by the sensors mounted in the greenhouse.

As a result of the comparison, if it is determined that the received growth environment information does not coincide with the greenhouse environment information (S303), the greenhouse control device 200 detects a sensor corresponding to the inconsistent environment information (S304) and actuates an actuator mapped to the detected sensor (S305). According to this exemplary embodiment of the present invention, if the growth environment information, which is distributed and received from the greenhouse environment control information distribution device 100, does not coincide with the greenhouse environment information, which is measured by the sensors mounted in the greenhouse, the greenhouse control device 200 detects a sensor corresponding to the inconsistent environment information and actuates an actuator mapped to the detected sensor.

According to this exemplary embodiment of the present invention, when the growth environment information, which is distributed and received from the greenhouse environment control information distribution device 100, does not coincide with the greenhouse environment information, which is measured by the sensors mounted in the greenhouse, if it is determined by the greenhouse control device 200 that the sensor corresponding to the inconsistent environment information is the CO₂ sensor for providing the CO₂ measurement service, and if it is determined from the comparison that the measured concentration of CO₂ in the greenhouse is lower than the predetermined concentration, the greenhouse control device 200 actuates the actuator for providing the CO₂ control service corresponding to the sensor for providing the CO₂ measurement service.

As described above, according to the method and system for adaptively controlling the greenhouse depending on the kind of crop growing in the greenhouse in accordance with the exemplary embodiments of the present invention, when various kinds of crops are grown in the greenhouse, it is possible to identify the information on appropriate environmental factors for each crop at any time and to provide the necessary growth conditions to the crops, thereby increasing the yield of the crops and improve the quality of the crops.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A system for controlling a greenhouse, the system comprising a greenhouse environment control information distribution device and a greenhouse control device, wherein the greenhouse environment control information distribution device comprises:
an information receiving unit for receiving information of a crop growing in a greenhouse, information of sensors mounted in the greenhouse, and information of actuators;
a selection unit for selecting a sensor service and an actuator service, which correspond to the received sensor information and actuator information, from a sensor service registry and an actuator service registry, respectively;
a mapping unit for mapping a sensor for providing the selected sensor service to an actuator for providing the selected actuator service; and
a distribution unit for extracting growth environment information from a database based on the crop information and the mapping information and distributing the extracted information to the greenhouse control device.

2. The system of claim 1, wherein the greenhouse control device compares the growth environment information, which is distributed and received from the greenhouse environment control information distribution device, with greenhouse environment information, which is measured by the sensors to determine whether the growth environment information coincides with the greenhouse environment information.

3. The system of claim 2, wherein if it is determined that the growth environment information does not coincide with the greenhouse environment information, the greenhouse control device detects a sensor corresponding to the inconsistent environment information.

4. The system of claim 3, wherein the greenhouse control device actuates an actuator mapped to the detected sensor.

5. The system of claim 1, wherein the database comprises growth environment information of a plurality of crops growing in the greenhouse.

6. A method for distributing greenhouse environment control information, the method comprising:
receiving information of a crop growing in a greenhouse, information of sensors mounted in the greenhouse, and information of actuators;
selecting a sensor service, which corresponds to the sensor information, from a sensor service registry;
selecting an actuator service, which corresponds to the actuator information, from an actuator service registry;
mapping a sensor for providing the selected sensor service to an actuator for providing the selected actuator service; and
extracting growth environment information from a database based on the crop information and the mapping information and distributing the extracted information.

7. The method of claim 6, wherein the database comprises growth environment information of a plurality of crops growing in the greenhouse.

8. A method for controlling a greenhouse environment, the method comprising:
receiving growth environment information of a crop growing in a greenhouse, which is determined based on the kind of crop growing in the greenhouse and distributed by a greenhouse environment control information distribution device;
comparing the received growth environment information with greenhouse environment information, which is measured by sensors for sensing the greenhouse environment information, to determine whether the growth environment information coincides with the greenhouse environment information;
if it is determined that the growth environment information does not coincide with the greenhouse environment information, detecting a sensor corresponding to the inconsistent environment information; and
actuating an actuator mapped to the detected sensor.
